(19) United States
(12) Patent Application Publication
(10) Pub. No.: US 2023/0114333 A1
(43) Pub. Date: Apr. 13, 2023

(54) METHOD AND DEVICE FOR MANAGING MULTIPLE PRESSES ON A TOUCH-SENSITIVE SURFACE

(71) Applicant: THALES, Courbevoie (FR)

(72) Inventors: Stéphanie LAFON, Martignas sur Jaille (FR); Laurent MOZER, Merignac (FR)

(21) Appl. No.: 17/909,978

(22) PCT Filed: Feb. 4, 2021
(86) PCT No.: PCT/EP2021/052656

§ 371 Date: Sep. 7, 2022

(30) Foreign Application Priority Data
Apr. 2, 2020 (FR) 2003293

(51) Int. Cl. G06F 3/041; G06F 3/01

(52) U.S. Cl. CPC G06F 3/04186; G06F 3/014; G06F 2203/04104

(57) ABSTRACT

A computer-implemented method and an associated device for managing multitouch presses on a touch surface are provided. The method includes at least steps of: during an interaction with a touch surface, computing at least parameters regarding the number, persistence and size of press points produced by conductive pads, the conductive pads being integrated into an interaction device worn by at least one user interacting with the touch surface, one of the faces of the conductive pads coming into interaction with the touch surface; identifying, from among a plurality of predefined interaction combinations, an interaction combination corresponding to the press points, based on the computed parameters, a predefined interaction combination being a configuration of multiple conductive pads that is associated with one or more actions; and carrying out the actions linked to the determined interaction combination.

The invention relates to the general field of human-machine interactions on tactile systems, and in particular proposes a device allowing multitouch presses or multitouch device, as it is commonly known, and a method for managing multitouch presses using such a device.

There are many modes of human-machine interaction, including interactions with physical or mechanical interactors (rotators, buttons, switches) or interactions with touch interactors or virtual interactors.

Technologies developed for human-machine interfaces (HMIs) in the context of virtual interactions are based on touchscreens or touchpads that allow a user to make selections by touching a display screen either directly or with a stylus-type object. The touchscreen recognizes the touch and the position of the touch on the display screen. This type of touch HMI commonly allows what are known as “simple-touch” or “multitouch” interactions.

An associated software driver makes it possible to interpret the touch so as then to carry out the action based on the touch event. Multitouch touch software drivers make it possible to detect the position of one or more simultaneous presses in the reference system of the screen. Some interactions are notably recognized, such as the simple press, the double tap, the release, the drag, and the pinch or gap between the index finger and the thumb. Interaction times may also be taken into account.

However, some problems may be encountered when interpreting the interaction, such as for example:
the detection of a simple press instead of a multiple press due to a problem with the synchronization of the pressing of each finger on the screen;
the detection of two simple presses instead of a double tap due to a problem with a pressing delay;
the detection of a press instead of a drag.

Complex timing mechanisms may be implemented in order to limit this type of error, but they generate latency.

Moreover, existing techniques do not make it possible to easily identify each finger, or the operator who is interacting. There is then a need for a solution that makes it possible to interpret the actions of an operator more easily.

Some techniques have emerged that attempt to detect the identity of a finger pressing on a screen. On capacitive screens, for example, the form of the press and its orientation provide certain indicators for this identification. A recent study on touch interactions in turbulence, “Design And Evaluation Of Braced Touch For Touchscreen Input Stabilization”, Cockburn et al., 2019, demonstrated the benefit of a technique called “Brace Touch”, which makes it possible to cancel out the action of the four fingers other than the index finger when the five fingers are pressed on the screen. This makes it possible to stabilize the hand by pressing on the touchscreen and to interact comfortably with the index finger. This approach is beneficial in environments where turbulence exists, and notably in the aeronautical field. However, it is limited to a single interaction configuration: 5 fingers pressed, 4 passive and 1 active useful for interaction in turbulence.

In the consumer sector, new interactors are emerging, such as for example “Surface Dial” from Microsoft©, which makes it possible to have a contextual interactor depending on the application launched on a terminal. This interactor may also be placed on a screen and then open a menu also linked to the application that is launched. The touch driver is then capable of recognizing the “Surface Dial” and of distinguishing it from fingers or a stylus. The disadvantage of this type of interactor is that it is mobile, and may therefore be easily misplaced. It is then not conceivable to use it in environments where it is strictly impossible to risk misplacing it, such as for example in an aircraft cockpit.

In the aeronautical field, the introduction of touchscreens is very recent. The problems linked to this technology are therefore new, and it is apparent that multitouch technology has limits in this environment. For example, some screens are shared by the pilot and the co-pilot, meaning that it is necessary to be able to identify the party who performs an action.

Moreover, there is an emerging need to allow generalization of the use of multitouch technology in cockpit-type environments, to be able to have more modes of interaction, and for these modes of interaction to be detected unambiguously, given the potential consequences of misinterpretation.

Finally, there is at present no satisfactory solution for securely managing touch interactions during turbulence, as has already been explained in the aeronautical context for example.

Therefore, in view of all of these problems, there is a need for a solution that makes it possible to unambiguously detect, in stable mode or in turbulence mode, a variety of multitouch touch presses, making it possible to identify the person who is interacting with the touch surface, and making it possible to identify the hand and/or the one or more fingers used to perform the interaction or safeguard it.

The invention makes it possible to address the abovementioned needs and to overcome the drawbacks of the known techniques.

Therefore, the invention proposes a solution based on a device worn by a user that comprises conductive pads, which makes it possible to perform a variety of interactions with a touch surface that are recognized unambiguously in a stable context or in a turbulent context.

Advantageously, positioning conductive pads in one or more supports worn by the user ensures permanent availability of the interactors. The interactions consist of presses representing specific configurations of pads that are unambiguously detected and recognized as predefined interaction combinations in order to trigger one or more associated actions.

Advantageously, the specific and unique presses offer a new mode of interaction with a touch surface, which makes it possible to lighten the other modes of interaction, i.e. physical interactors or touch HMIs. Thus, in one mode of implementation of the method of the invention, an action generated by an interaction on a touch surface with the device of the invention may be the opening of a menu following the recognition of a configuration of conductive pads stemming for example from a press of the edge of the hand. The advantage is then that of avoiding adding a new button or displaying a new interactive item on the HMIs. Advantageously, the proposed solution therefore makes it possible to design more refined HMIs.

Another subject of the present invention is a method for identifying multitouch presses in order to recognize notably the person who has interacted with the touch surface, to recognize the one or more hands, or to recognize the one or more fingers used. Advantageously, identifying the user who is interacting with a touchscreen makes it possible to offer a personalized and protected environment.

Moreover, the proposed solution allows multiple operators to interact at the same time on one and the same workspace, i.e. one or more touchpads/touch surfaces/touchscreens, and in a personalized manner.

The present invention may be applied in various industrial sectors, and be used for numerous applications. It may notably cover a set of uses suited to touch HMIs in aircraft cockpits.

To obtain the desired results, what is generally proposed is a device worn by a user comprising a plurality of conductive pads, which may be of various sizes and of various shapes. During an interaction with a touchscreen by a user, the faces of the pads that come into contact with the screen are detected as presses, by a touch driver coupled to the touch interaction surface. Depending on the number, size, shape, layout of the pads in relation to one another and their location on the device, the pads form configurations of conductive pads that create unique interaction combinations. The software method of the invention makes it possible to determine the specific configuration of the conductive pads corresponding to a multitouch press that is detected, and then makes it possible to trigger the specific action that is predefined for this configuration.

Generally speaking, the computer-implemented method for managing multitouch presses on a touch surface comprises steps of:
during an interaction with a touch surface, computing at least parameters regarding the number, persistence and size of press points produced by conductive pads, said conductive pads being integrated into an interaction device worn by at least one user interacting with the touch surface, one of the faces of the conductive pads coming into interaction with the touch surface;
identifying, from among a plurality of predefined interaction combinations, an interaction combination corresponding to said press points, based on the computed parameters, a predefined interaction combination being a configuration of multiple conductive pads that is associated with one or more actions; and
carrying out the actions linked to the determined interaction combination.

According to some alternative or combined embodiments:
the step of computing the number of press points comprises a step of checking that this number is greater than or equal to a minimum number corresponding to the smallest number of conductive pads of the predefined interaction combinations.
the step of computing the size of the press points comprises a step of checking that the size of the press points corresponds at least to a predefined pad size for the predefined interaction combinations.
the step of identifying an interaction combination comprises a step of computing the distance between the press points, and then a step of determining whether, in the predefined interaction combinations, there is a set with the same number of points in which the mutual distances correspond to the computed distance.
the step of identifying an interaction combination implements a shape recognition algorithm.
the step of identifying an interaction combination comprises a step of identifying said at least one user who performed the press.
the step of identifying an interaction combination comprises a step of defining a touch inhibition area, allowing any new touch press in this area not to be interpreted for the duration of the step of carrying out the actions.
the step of carrying out actions comprises a step of activating a software module corresponding to the identified interaction combination, configured to carry out said actions.
the method furthermore comprises a step of checking and validating the persistence of the interaction combination.
the persistence checking step implements a path tracking algorithm to check the persistence of each press point.
the persistence checking step comprises a step of deactivating said software module if the persistence is no longer validated.

The invention also covers a device for managing multitouch presses on a touch surface, the device comprising means for implementing the steps of the claimed method.

In one embodiment, the touch surface consists of multiple touchscreens.

In one embodiment, the interaction device integrating conductive pads is a glove, a bracelet, a finger cot or a ring.

In one embodiment, the user is a pilot and a co-pilot, each wearing an interaction device.

The invention also covers a computer program product comprising code instructions for performing the steps of the claimed method when the program is executed on a computer.

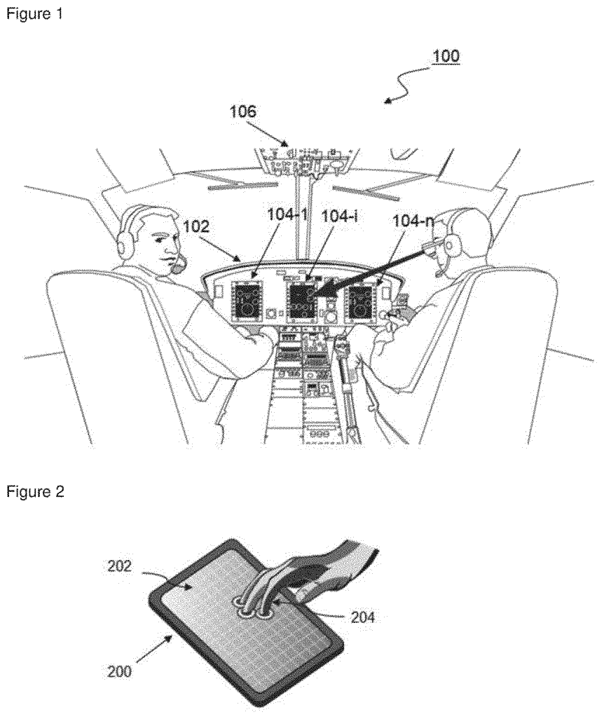

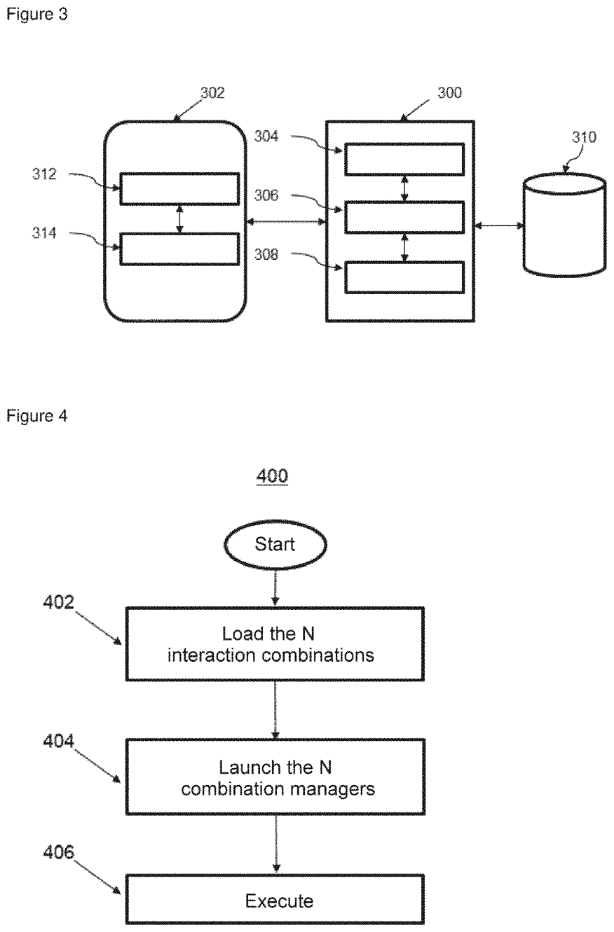

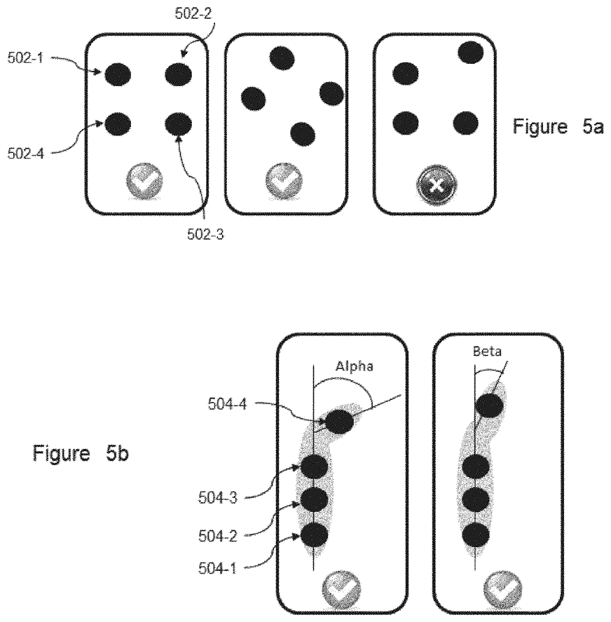

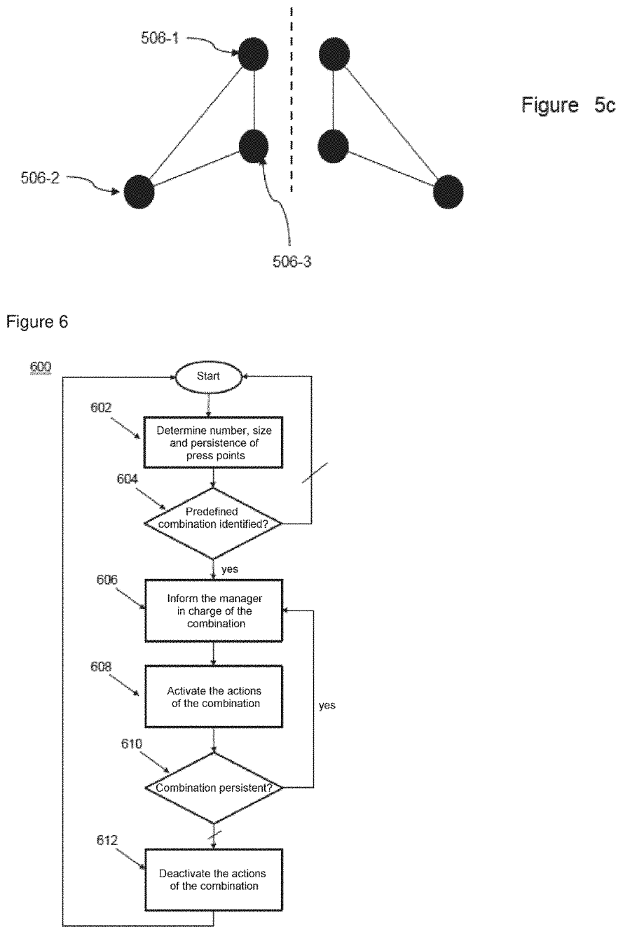

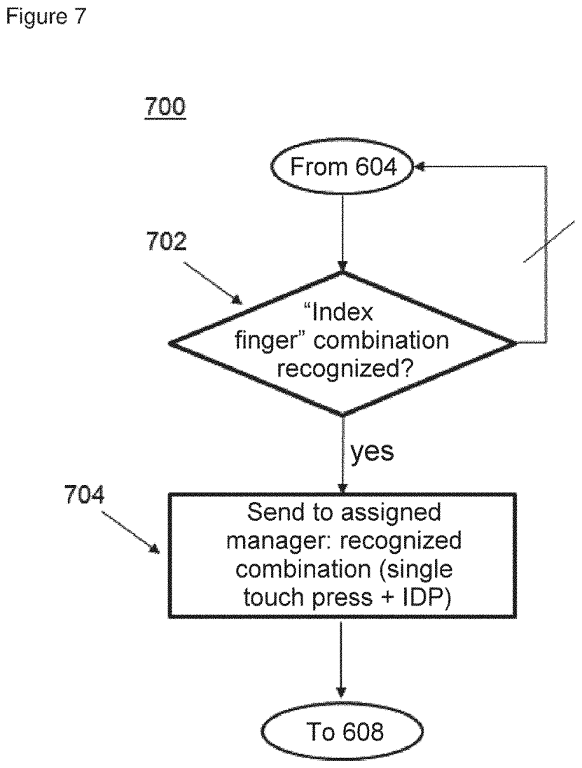

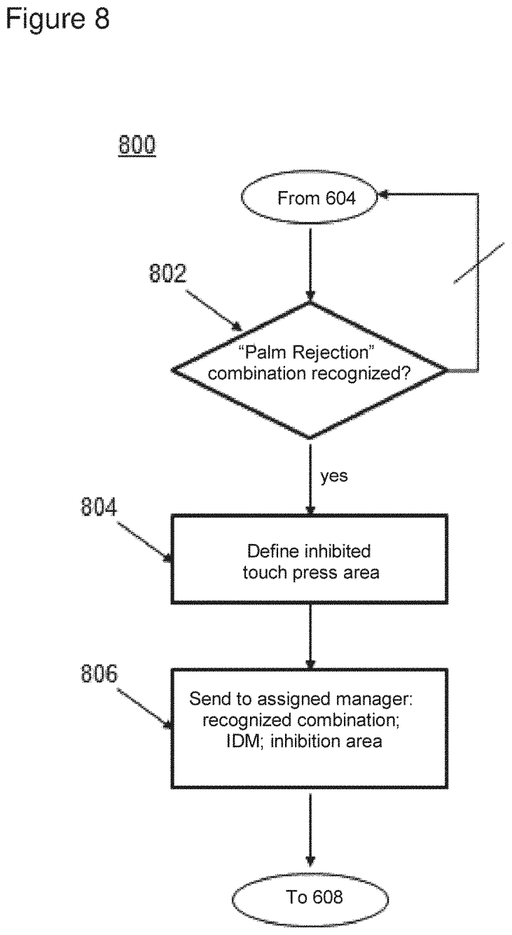

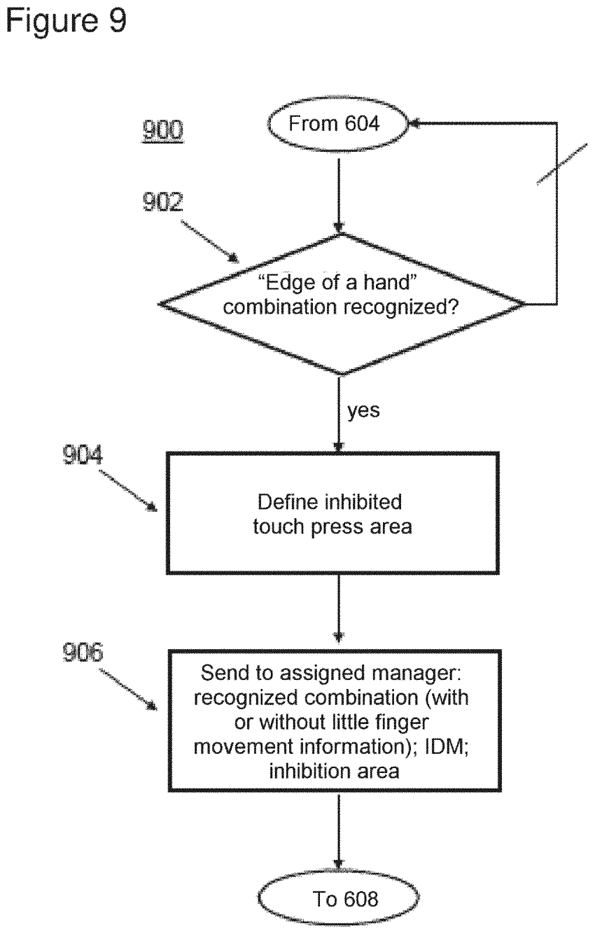

Other features, details and advantages of the invention will become apparent on reading the description given with reference to the appended drawings, which are given by way of example and in which, respectively:

[FIG. 1] shows an aircraft cockpit environment for implementing the device of the invention;

[FIG. 2] shows one example of a touch tablet for implementing the interaction detection method of the invention, according to one embodiment;

[FIG. 3] shows a diagram of the components of the device of the invention, according to one embodiment;

[FIG. 4] shows a procedure for initializing a touch driver for managing interactions, according to one embodiment;

[FIG. 5a]

[FIG. 5b]

[FIG. 5c] show exemplary configurations of conductive pads according to the principle of the invention;

[FIG. 6] shows a sequence of steps for managing the actions linked to the recognition of a configuration of conductive pads during an interaction, according to one embodiment of the invention;

[FIG. 7] shows a sequence of steps relating to the recognition of an interaction combination called “Index finger”;

[FIG. 8] shows a sequence of steps relating to the recognition of an interaction combination called “Palm Rejection”; and

[FIG. 9] shows a sequence of steps relating to the recognition of an interaction combination called “Edge of the hand”.

FIG. 1 shows an aircraft cockpit environment 100 allowing pilots to use the device of the invention. The cockpit notably comprises, as is well known, an instrument panel 102, a ceiling light 106, actuators, joysticks and other conventional cockpit instruments, and display screens 104-1 to 104-n. The display screens may be equipped with human-machine interfaces (HMIs) allowing the pilots to interact in order to trigger commands and actions. Some HMIs may be fully or partially touch surfaces. It is considered in the remainder of the description that an interaction surface such as the display screen and a touch surface form a single interaction unit.

The graphics screens comprise or are coupled to graphics information processing means, for example a graphics processor and an associated graphics memory, the graphics processor being designed to process graphics information stored in a graphics memory and display said information on a screen.

FIG. 2 schematically illustrates a touch tablet 200 for implementing the interaction detection method of the invention according to one embodiment, and comprising a touch surface 202 with which a user wearing an interaction device 204 according to the invention is able to interact, in one embodiment. The example is simplified, and the invention is not limited to this type of tablet, but may be implemented in any other equivalent device, be this a laptop or desktop computer, a personal assistant, a mobile telephone, etc. or any other device able to offer a touch interaction surface for at least one user.

A person skilled in the art is aware that there are various touch surface technologies, the two main ones being capacitive touch surfaces and resistive touch surfaces. These technologies are not described, but make it possible to implement the method of the invention with adaptations specific to each technology.

Without this being illustrated, the tablet from FIG. 2 is a computing device with a processing unit that notably comprises a processor and a memory able to contain software programs. The tablet may additionally be equipped with various modules or input/output connectors allowing communications other than touch communications, i.e. audio and video communications, wireless, Wi-Fi, Bluetooth, USB connector-based, HDMI, etc. communications.

The interaction device 204 worn by a user comprises conductive pads that will make it possible to interact with a touch surface via one face. The other face of a conductive pad may, according to the embodiments, either be in direct contact with the skin or be fastened to an object worn by the user without direct contact with the skin (the object being for example a glove, a bracelet, etc.), or be fastened to an object that may be grasped by the user (the object being for example a capsule, a pencil, a mouse, etc.).

Thus, according to various embodiments, the interaction device of the invention integrating conductive pads may take the form notably of a glove, a bracelet, a finger cot, a ring, etc.

The pads will be organized on one or more flat areas of the interaction device so as to produce configurations of conductive pads that will be able to be recognized during an interaction with a touch surface as the same number of different configurations. In one embodiment of the interaction device in the form of a pilot's glove, conductive pads may be integrated into the fingertips of the glove, and/or on the side corresponding to the edge of a hand and/or the inside of the wrist and/or on the palm. It thus becomes apparent that a single embodiment of the interaction device of the invention makes it possible to provide a variety of configurations of conductive pads, each configuration corresponding to an interaction combination for defining a multitouch press. Moreover, advantageously by virtue of the interaction device of the invention, areas are created where the pads cannot be dissociated, thus reducing the risks of presses being misinterpreted.

FIG. 3 schematically illustrates the components of the processing unit 300 of a tablet configured to implement the method of the invention, according to one embodiment. The processing unit 300 is coupled to a touch driver 302 that provides the interface with the touch surface and is configured to detect an interaction using the technology of the touch surface. The processing unit 300 comprises a processor 304 designed to execute software programs comprising code instructions, stored in one or more modules 306, 308, in order to carry out the steps of the method of the invention. The processing unit 300 comprises, or is coupled to, a database 310 for storing notably parameters relating to the configurations of conductive pads, parameters defining user profiles.

In one embodiment, the touch driver 302, which, on the one hand, is configured (press detection module 312), using touch surface technology, to detect presses (i.e. determine coordinates of a press) and detect types of interaction (i.e. pinches, presses, double presses, etc.), furthermore comprises an interaction combination management module 314, which is configured to determine the specific configurations of the conductive pads when the touch surface is pressed.

During an interaction with the touch surface, the touch driver detects the presses using the press detection module 312, designed for touch surface technology, and the detected presses will be analyzed with regard to the predefined configurations in the interaction management module 314 to determine what specific configuration of pads are present in the press, and if necessary use the software modules of the processing unit 300 to carry out the corresponding operations.

FIG. 4 illustrates steps carried out in the touch driver 312 to initialize the interaction combination management module 314. In a first step 402, the method makes it possible to define and load a plurality of interaction combinations corresponding to a plurality of configurations of conductive pads.

In one embodiment, each combination is characterized by parameters regarding:
number of presses N_{P}, i.e. number of conductive pads;
for each press: a unique identifier, which is the identifier of the combination ID_{comb} to which the pad belongs; a shape (i.e. a pad shape); a size (i.e. a pad size); a type of press (i.e. fixed or mobile pad). Advantageously, the choice of a shape and/or a size for each pad, together with the location of the pad, for example placed at the fingertips of a glove, will make it possible to identify, when analyzing the press, the person who triggered the press using this finger. As an alternative, a different number of pads may be selected to define a combination for each finger. A person skilled in the art will thus understand that an unlimited variety of combinations may be adapted to the use case of the device of the invention;
the distance of each press of a pad from each other press of the combination;
defining functions, actions to be performed during execution.

Once all of the combinations have been defined, the method makes it possible, in a following step 404, to activate all of the interaction managers, which are each assigned to the recognition of a predefined combination. All of the managers are active while carrying out the press detection process described with reference to FIG. 6.

FIGS. 5a to 5c illustrate various exemplary configurations of conductive pads defining interaction combinations according to the principle of the invention.

FIG. 5a, in the examples on the left and in the middle, shows a configuration of conductive pads 502-1 to 502-4 defining a square interaction combination. The four conductive pads may for example be positioned at a given distance in a square on the pilot's wrist. Such a configuration will be detected and recognized by the method of the invention regardless of the orientation of the square. By contrast, the example on the right of FIG. 5a illustrates a layout of pads that does not make it possible to define and therefore to recognize a square interaction combination.

FIG. 5b shows another configuration embodiment of multiple conductive pads. In the example illustrated, four conductive pads are combined so as to form a specific configuration comprising fixed and mobile pads, without this number however being interpreted as a limitation, any configuration of conductive pads being able to comprise from two to N conductive pads. In this configuration suitable for the edge of the hand, conductive pads 504-1 to 504-4 are positioned in a row in a glove or a finger cot so as to be in contact with the outer edge of a hand via one face, and come into contact with a touch surface during an interaction via the other face. Advantageously, as illustrated, the layout of pads may comprise fixed pads 504-1 to 504-3 placed in an area of a glove corresponding to the outer edge of the hand, and a mobile pad 504-4 placed in an area of the glove corresponding to the outer edge of the little finger. A configuration of pads that combines fixed pads and mobile pads may thus be detected and, depending on the angle that is formed between the row of fixed pads (the outer edge of the hand) and the row of the mobile pads (the finger), one or more actions are triggered. Advantageously, defining a configuration that combines fixed and mobile pads makes it possible to increase the possibilities for a user to deliver specific information regarding his intention. Preferably, the fixed pads should be positioned in the interaction device on an area corresponding to a flat area of the user, such as for example the wrist, the fingertip, the edge of the hand.

FIG. 5c illustrates a configuration of conductive pads that makes it possible to define what is called a “mirror” interaction combination. In the example illustrated, the configuration comprises three conductive pads 506-1 to 506-3 positioned in a triangle, thus making it possible to define, through symmetry, a mirror combination, represented here by the three pads defining the second triangle. Advantageously, using symmetrical configurations makes it possible to define dual interaction combinations such as: “left/right”; “pilot/co-pilot” for example.

FIG. 6 illustrates a sequence of steps 600 for managing the actions linked to the recognition of a configuration of conductive pads during an interaction, according to one embodiment of the method of the invention. The method begins after the detection, by a touch driver, of a press on a touch surface.

In a first step 602, the method makes it possible to analyze the press points according to multiple features. In one preferred embodiment, the method makes it possible to compute:
the number N of press points, and check whether this number N is greater than or equal to a minimum number Nₘᵢₙ corresponding to the smallest number of conductive pads of at least one combination from among the set of predefined interaction combinations;
the persistence of the N press points, by measuring the time for which the N points remain pressed. Persistence is a parameter that may be predefined depending on the touch technology and the nature of the application. In one embodiment in the context of an aircraft cockpit, the persistence threshold may be set to 2 seconds;
the size of the press points (for example the diameter in pixels), and check whether the size of the N press points corresponds at least to a press point size predefined by the interaction combination manager. In one embodiment, a tolerance margin may be predefined so as to consider that the comparison of the size of the press points is identical to a predefined size.

When the various parameter computations have been performed, the method makes it possible, in a following step 604, to characterize the configuration of the conductive pads of the press so as to identify whether this configuration corresponds to a predefined interaction combination and, if so, to which one. Preferably, the method makes it possible to compute the distance between the N press points, and then to determine whether, in the predefined interaction combinations, there is a set with the same number N of points in which the mutual distances correspond to the computed distance.

In one embodiment, the step of identifying the combination may implement a shape recognition algorithm to recognize a shape corresponding to the press. In another embodiment, the step of identifying the combination makes it possible to determine the orientation of the shape of the press (using a computation based on the vector product) and also to define a contour encompassing the shape. A person skilled in the art will understand that, for some configurations, it may be useful to compute other parameters that characterize the configuration, such as the barycenter of multiple press points for example, in the case of an index finger identification (i.e. two pads placed at the tip of the index finger). In another embodiment, the step of identifying the combination may also implement a moving point processing algorithm.

If step 604 validates the recognition of a predefined interaction combination, the method makes it possible, in a following step 606, to inform the interaction manager assigned to the corresponding combination, and then, in a following step 608, to activate the one or more corresponding software modules configured to carry out said actions, by sending them the information useful for managing this interaction (i.e. the barycenter of the pads placed at the tip of an index finger or of another finger, an inhibition area, a user identifier), in order to initiate the carrying out of the operations defined for this combination.

In a following step 610, the method makes it possible to check the persistence of the interaction combination that has been recognized. In particular, the method implements a path tracking algorithm to check the persistence of each point (i.e. check whether each conductive pad remains pressed). In one embodiment, the path tracking algorithm is a mobile shape tracking algorithm.

The method continues (yes branch) for as long as the persistence of the combination that has been recognized is validated, or else the method ends by deactivating 612 the one or more software modules implementing the actions linked to the interaction combination.

FIGS. 7 to 9 illustrate three examples of sequences of steps for triggering respective actions following the recognition of a configuration of conductive pads (step 604).

FIG. 7 thus shows a sequence of steps 700 relating to the recognition of a configuration of conductive pads associated with what is called an “Index finger” interaction combination. Following the analysis of a press detected on a touch surface (step 602 of FIG. 6), the method compares the configuration of pads with the various predefined configurations. If the recognized configuration corresponds to a predefined “Index finger” interaction combination (yes branch in step 702), the method makes it possible to send 704, to the interaction manager assigned to this “Index finger” interaction combination, information that an “Index finger” press has been detected, in order to initiate the actions linked to this press. In one embodiment, the transmitted information corresponds to single press information representing the barycenter of the points of the configuration of the pads at the fingertip. In another embodiment, an identifier of the person “ID_{P}” who performed the press is sent, making it possible to trigger the predefined specific actions linked to the press of the index finger by this person (i.e. the pilot or the co-pilot). The method continues with step 608.

FIG. 8 shows a sequence of steps 800 relating to the recognition of a configuration of conductive pads associated with what is called a “Palm Rejection” interaction combination. If a configuration that is recognized corresponds to the “Palm Rejection” interaction combination (yes branch in step 802), the method makes it possible to define 804 a touch inhibition area that makes it possible not to dissociate the pads from the configuration, and to ensure that any new touch press in this area will not be interpreted for as long as the persistence of the initial press is verified. In one embodiment, the touch inhibition area is an encompassing rectangle-like shape, representing the configuration of the conductive pads. In another embodiment, the touch inhibition area is defined by a shape different from the configuration of the conductive pads, but encompassing said shape. In a following step 806, the method makes it possible 806 to send, to the interaction manager assigned to this “Palm Rejection” interaction combination, information that a “Palm Rejection” press has been detected, in order to initiate the actions linked to this press. In one embodiment, the transmitted information comprises identification information ID_{M} regarding the hand of the person who performed the press. In another embodiment, the transmitted information comprises information regarding the touch inhibition area that is defined. The method continues with step 608.

FIG. 9 shows a sequence of steps 900 relating to the recognition of a configuration of conductive pads associated with what is called an “Edge of a hand” interaction combination. If a configuration that is recognized corresponds to the “Edge of a hand” interaction combination (yes branch in step 902), the method makes it possible to define 904 a touch inhibition area that makes it possible not to dissociate the pads from the configuration, and to ensure that any new touch press in this area will not be interpreted for as long as the persistence of the initial press is verified. In one embodiment, the touch inhibition area is an encompassing shape covering all of the conductive pads of the “Edge of a hand” configuration. The encompassing shape makes it possible to take into account the presence of fixed and mobile pads (i.e. pad on the little finger). In a following step 906, the method makes it possible to send, to the interaction manager assigned to this “Edge of a hand” interaction combination, information that an “Edge of a hand” press has been detected, in order to initiate the actions linked to this press. In one embodiment, the transmitted information also comprises information regarding a movement of a mobile pad (i.e. value of the angle formed by the row of fixed pads with the row of mobile pads) so as to make it possible to trigger the corresponding actions (i.e. the scrolling of certain pages depending on the angle of rotation of the finger). In one embodiment, the transmitted information comprises identification information Dm regarding the hand of the person who performed the press. In another embodiment, the transmitted information comprises information regarding the touch inhibition area that is defined. The method continues with step 608.

Uses of the described configurations are particularly advantageous in an aircraft cockpit. Specifically:

A configuration associated with a “Palm Rejection” combination may allow pilots to put their wrists on a screen without this press interacting with the HMIs by virtue of the inhibition area.

Using one and the same device, with specific configurations of conductive pads on each wrist of a glove, the left hand and the right hand of the pilot may be recognized and differentiated by mirror combinations.

Identifying finger presses makes it possible to offer individual and personalized interactions. For example, by identifying a pilot's index finger: if an “Index finger” interaction combination is loaded on initialization, this means that the standard operation of the touch driver will be modified, and the press of the index finger will then be specific to its owner. Thus, for example, the commander may have two pads (or one pad with a particular shape), positioned at a specific distance from one another on each of his index fingers, while the co-pilot has none. The touch pilot then checks whether the press is performed with 1 or 2 close presses using the two close pads (or checks the shape of the pads), and determines whether the interaction originates from the commander or his co-pilot (this is particularly useful for example for activating a microphone in voice command mode), the other interactions not being changed.

Identifying presses of the pilot or co-pilot may allow interaction with multiple parties on one and the same screen. This is useful for example for ascertaining which person to listen to when a touch press launches voice recognition.

Interacting using one or more edges of the hand makes it possible to open personalized menus.

A glove with a unique identifier makes it possible to recognize the pilot wearing the glove and/or to open an identification panel in order to launch critical actions for example.

Variant embodiments may be considered, proceeding from the basic principle of the invention. It is thus possible to couple the recognition of a configuration of conductive pads with another mode, such as for example voice recognition or gaze recognition. This makes it possible to change the action associated with the recognized combination based on a voice command uttered by the user in addition to the touch press. The same principle may be derived for the association of the recognition of a configuration of conductive pads depending on an area observed by the user.

According to some embodiments, the mode of interaction may be different depending on the area of the HMI in which the presses are located. This is advantageously applicable for what are known as “free form” HMIs, which consist of areas with linear or curved contours.

Other variant embodiments may combine multiple combinations that are performed on one and the same touch surface or on remote touch surfaces. This is of interest for example when starting up the cockpit with the identification of the two pilots in a dedicated HMI that is displayed on the two screens facing the pilots. Said pilots may for example each press their palm at the same time on a dedicated area so as to allow individual identification.

The present description thus illustrates one preferred but non-limiting implementation of the invention. Examples are chosen so as to allow a good understanding of the principles of the invention and a specific application, but are in no way exhaustive and should allow a person skilled in the art to make modifications and implementation variants while retaining the same principles.

1. A computer-implemented method for managing multitouch presses on a touch surface, the method comprising at least steps of:
during an interaction with a touch surface, computing at least parameters regarding the number, persistence and size of press points produced by conductive pads, said conductive pads being integrated into an interaction device worn by at least one user interacting with the touch surface, one of the faces of the conductive pads coming into interaction with the touch surface;
identifying, from among a plurality of predefined interaction combinations, an interaction combination corresponding to said press points, based on the computed parameters, a predefined interaction combination being a configuration of multiple conductive pads that is associated with one or more actions; and
carrying out the actions linked to the determined interaction combination.

2. The method as claimed in claim 1, wherein the step of computing the number of press points comprises a step of checking that this number is greater than or equal to a minimum number corresponding to the smallest number of conductive pads of the predefined interaction combinations.

3. The method as claimed in claim 1, wherein the step of computing the size of the press points comprises a step of checking that the size of the press points corresponds at least to a predefined pad size for the predefined interaction combinations.

4. The method as claimed in claim 1, wherein the step of identifying an interaction combination comprises a step of computing the distance between the press points, and then a step of determining whether, in the predefined interaction combinations, there is a set with the same number of points in which the mutual distances correspond to the computed distance.

5. The method as claimed in claim 1, wherein the step of identifying an interaction combination implements a shape recognition algorithm.

6. The method as claimed in claim 4, wherein the step of identifying an interaction combination comprises a step of identifying said at least one user who performed the press.

7. The method as claimed in claim 1, wherein the step of identifying an interaction combination comprises a step of defining a touch inhibition area, allowing any new touch press in this area not to be interpreted for the duration of the step of carrying out the actions.

8. The method as claimed in claim 1, wherein the step of carrying out actions comprises a step of activating a software module corresponding to the identified interaction combination, configured to carry out said actions.

9. The method as claimed in claim 6, furthermore comprising a step of checking and validating the persistence of the interaction combination.

10. The method as claimed in claim 9, wherein the persistence checking step implements a path tracking algorithm to check the persistence of each press point.

11. The method as claimed in claim 10, comprising a step of deactivating said software module if the persistence is no longer validated.

12. A device for managing multitouch presses on a touch surface, the device comprising means for implementing the steps of the method as claimed in claim 1.

13. The device as claimed in claim 12, wherein the touch surface consists of multiple touchscreens.

14. The device as claimed in claim 12, wherein the interaction device integrating conductive pads is a glove, a bracelet, a finger cot or a ring.

15. The device as claimed in claim 12, comprising means for predefining dual interaction combinations such as “left/right” or “pilot/co-pilot”.

16. A computer program comprising code instructions for carrying out the steps of the method as claimed in claim 1 when said program is executed by a processor.
